(19) United States
(12) Patent Application Publication
(10) Pub. No.: US 2025/0208366 A1
(43) Pub. Date: Jun. 26, 2025

(54) FIXATION OF NON-ROUND CABLES AND OF CABLES EXTERIOR TO A CLOSURE VOLUME

(71) Applicant: CommScope Technologies LLC,, Hickory, NC (US)

(72) Inventors: Philippe COENEGRACHT, Hasselt (BE); Olivier C. ROCHE, Schaerbeek (BE); Matthew CAMPSTEYN, Hoeselt (BE); Eddy Luc CAMS, Bilzen (BE); William B. BRYAN, Fuquay-Varina (NC); Erik David BISHOP, Fuquay-Varina, NC (US); Ronnie Rosa Georges LIEFSOENS, Tessenderlo (BE)

(73) Assignee: CommScope Technologies LLC, Hickory, NC (US)

(21) Appl. No.: 18/849,583

(22) PCT Filed: Mar. 21, 2023
(86) PCT No.: PCT/US2023/064774

§ 371 Date: Sep. 23, 2024

Related U.S. Application Data
(60) Provisional application No. 63/323,591, filed on Mar. 25, 2022.
(60) Provisional application No. 63/384,810, filed on Nov. 23, 2022.
(60) Provisional application No. 63/488,232, filed on Mar. 3, 2023.

(51) Int. Cl. G02B 6/44

(52) U.S. Cl. CPC G02B 6/44765; G02B 6/4433; G02B 6/4444; G02B 6/44785

(57) ABSTRACT

Devices and assemblies for fixation of non-round cables. Devices and assemblies for fixation of cables interior to and exterior to, a cable sealing module of a telecommunications closure.

### CROSS-REFERENCE TO RELATED APPLICATION

This application is being filed on Mar. 21, 2023, as a PCT International application and claims the benefit of and priority to U.S. Patent Application No. 63/323,591, filed on Mar. 25, 2022, and claims the benefit of U.S. Patent Application No. 63/384,810 filed Nov. 23, 2022 and claims the benefit of U.S. Patent Application No. 63/488,232 filed Mar. 3, 2023, the disclosures of which are hereby incorporated by reference in their entirety.

### TECHNICAL FIELD

The present disclosure relates to improvements in fixation of cables at telecommunications equipment.

### BACKGROUND

Optical fibers of telecommunications networks are managed at telecommunications equipment located at different network distribution locations. Such telecommunications equipment can include closures, cabinets, shelves, panels and so forth. The equipment typically includes management assemblies to organize, store, route and connect optical fibers within the network. For example, optical fibers from provider side cables can be routed and optically connected to optical fibers of subscriber side cables using such assemblies. The assemblies can include features for supporting optical fiber splices, ferrules, connectors, adapters, splitters, wave division-multiplexers and so forth. In addition, the assemblies can include features for storing and protecting optical fibers.

Cables carrying optical cables enter a closure through sealed ports, and must be fixed to the assembly so that the optical fibers extending from the cables within the closure can be managed on the assembly without the potentially deleterious effects of the cables shifting such as causing damage to the delicate optical fibers and compromising the seal around the cables.

### SUMMARY

In general terms, the present disclosure relates to improvements in fixation of non-round cables.

In further general terms, the present disclosure relates to fixation of cables exterior to an interior volume of a telecommunications closure.

In further general terms, the present disclosure relates to improvements in fiber optic closures and other fiber optic distribution equipment.

As used herein, a “non-round cable” is a cable having an outer jacket surrounding one or more optical fibers, wherein the outer jacket has a cross-section perpendicular to the longitudinal axis of the cable that is not round and not substantially round. Examples of non-round cables can include a cable whose outer jacket has a cross-sectional shape perpendicular to the longitudinal axis that is an oval, a rectangle, a racetrack shape, etc. A “flat cable” is a type of non-round cable. A flat cable typically has an outer jacket having a cross-sectional shape perpendicular to the longitudinal axis that is a race-track shape, with two flat portions on opposite sides connected to each other by two curved portions. Flat cables can, e.g., carry flat or rollable optical fiber ribbons. A “cable”, as used herein, includes an outer jacket extending along a longitudinal axis of the cable and surrounding one or more optical fibers and/or one or more other signal conduits, such as copper wires.

According to certain aspects of the present disclosure, a fixation device for a cable extending along a central longitudinal axis and having an outer jacket defining a non-round cross-sectional profile perpendicular to the axis, includes: a main body; walls projecting from the main body and defining a slot between the walls, the slot having an open end; and blades projecting from the walls towards a center of the slot.

According to further aspects of the present disclosure, an assembly for affixing cables, each cable extending along a central longitudinal axis and having an outer jacket defining a non-round cross-sectional profile perpendicular to the axis, includes: a main body configured to lockingly mount to a base of a telecommunications closure; and a fixation device configured to be slidingly received by the main body to lockingly mount the fixation device to the main body, the fixation device including: a base defining pockets arranged in a row; walls projecting from the base and defining slots between adjacent pairs of the walls, each slot having an open end, the slots being arranged in a row parallel to the row of the pockets, each slot being aligned with one of the pockets; and blades projecting from the walls towards a center of each slot, wherein each slot is configured to receive one of the cables through the open end along a direction parallel to an elongate transverse axis of the cable while a corresponding one of the pockets receives a strength rod of the cable.

According to further aspects of the present disclosure, an assembly for a telecommunications closure defining an interior volume and an exterior, includes: a cable seal member; an interior cable fixation subassembly positioned in the interior volume on an interior side of the cable seal member, the interior cable fixation subassembly being configured to affix an interior portion of an outer jacket of a cable extending through the cable seal member; and an exterior cable fixation subassembly positioned at the exterior at an exterior side of the cable seal member, the exterior cable fixation subassembly being configured to affix an exterior portion of the outer jacket of the cable extending through the cable seal member.

According to further aspects of the present disclosure, a method, includes: providing a non-round cable having an outer jacket, one or more optical fibers, and a pair of eccentric strength rods having portions extending beyond an end of the jacket; cutting the portion of one of the rods so that the cut portion is shorter than the portion of the other of the rods; inserting the portion of the other of the rods in a pocket; and inserting the jacket into a slot such that blades within the slot dig into the jacket.

According to further aspects of the present disclosure, an assembly for affixing cables, each cable extending along a central longitudinal axis and having an outer jacket defining a non-round cross-sectional profile perpendicular to the axis, includes: a main body configured to lockingly mount to a piece of a telecommunications closure, the main body defining pockets arranged in a row; and a fixation device configured to be received by the main body to lockingly mount the fixation device to the main body, the fixation device including: a base; a pair of walls or arms projecting from the base and defining a slot therebetween, the slot having an open end, the slot being aligned with a corresponding one of the pockets; and blades projecting from the walls or arms towards a center of the slot, wherein the slot is configured to receive one of the cables through the open end along a direction parallel to an elongate transverse axis of the cable while the corresponding one of the pockets receives a strength rod of the cable.

According to further aspects of the present disclosure, an assembly for affixing cables, each cable extending along a central longitudinal axis and having an outer jacket defining a non-round cross-sectional profile perpendicular to the axis, includes: a main body configured to lockingly mount to a piece of a telecommunications closure, the main body defining pairs of receivers arranged in a row; and fixation devices, each fixation device being lockingly received in one of the pairs of receivers, each fixation device including: a base; a pair of arms projecting from the base; and blades projecting from the arms towards each other, wherein orientations of adjacent ones of the fixation devices are opposite each other, the orientations alternating along a row of the fixation devices.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

The following drawings are illustrative of particular embodiments of the present disclosure and therefore do not limit the scope of the present disclosure. The drawings are not necessarily to scale and are intended for use in conjunction with the explanations in the following detailed description. Embodiments of the present disclosure will hereinafter be described in conjunction with the appended drawings, wherein like numerals denote like elements.

FIG. 1 is a perspective view of example telecommunications equipment to which cables can be affixed according to the present disclosure.

FIG. 2 is a perspective view of a portion an example fiber management assembly that can be housed in the equipment of FIG. 1.

FIG. 3 is a perspective view of the base assembly of the equipment of FIG. 1.

FIG. 4 is a further perspective view of the base assembly of FIG. 3.

FIG. 5 is a perspective view of a portion of the base assembly of FIG. 3.

FIG. 6 is a perspective view of a further portion of the base assembly of FIG. 3.

FIG. 7 is a perspective view of a non-round cable subassembly that can be mounted to the base assembly of FIG. 3, and including flat cables affixed thereto.

FIG. 8 is a further perspective view of the non-round cable subassembly of FIG. 7.

FIG. 9 is a perspective view of the fixation device of the subassembly of FIG. 7.

FIG. 10 is a further perspective of the fixation device of FIG. 9.

FIG. 11 is a perspective view of the main body of the subassembly of FIG. 7.

FIG. 12 is a further perspective view of the main body of the subassembly of FIG. 7.

FIG. 13 is a further perspective view of the main body of the subassembly of FIG. 7.

FIG. 14 is a further perspective view of the main body of the subassembly of FIG. 7.

FIG. 15 is a perspective view of an example exterior cable fixation subassembly according to the present disclosure that can be mounted to the base assembly of FIG. 3, the subassembly including a support body and a cable clamp.

FIG. 16 is a further perspective view of the subassembly of FIG. 15.

FIG. 17 is a partially exploded view of the subassembly of FIG. 15.

FIG. 18 is perspective view of further example cable clamp that can be used with the support body of FIG. 15.

FIG. 19 is a further perspective view of the cable clamp of FIG. 18.

FIG. 20 is a perspective view of a further example support body that can be used with the cable clamp of FIG. 15 or the cable clamp of FIG. 19.

FIG. 21 is a perspective, partially exploded view of the non-round cable subassembly of FIG. 7.

FIG. 22 is a perspective view of a further example interior cable fixation subassembly according to the present disclosure.

FIG. 23 is a further perspective view of the subassembly of FIG. 22.

FIG. 24 is a cross-sectional view of the subassembly of FIG. 22.

FIG. 25 is a perspective view of one of the cable subassemblies of the subassembly of FIG. 22.

FIG. 26 is a further perspective view of the cable subassembly of FIG. 25.

FIG. 27 is a perspective view of the cable fixation device of the cable subassembly of FIG. 25.

FIG. 28 is a further perspective view of the cable fixation device of the cable subassembly of FIG. 25.

FIG. 29 is a perspective view of the main body of the subassembly of FIG. 22.

FIG. 30 is a further perspective view of the main body of FIG. 29.

FIG. 31 is a top, planar view of the main body of FIG. 29.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Any examples set forth in this specification are not intended to be limiting and merely set forth some of the many possible embodiments for the claimed invention.

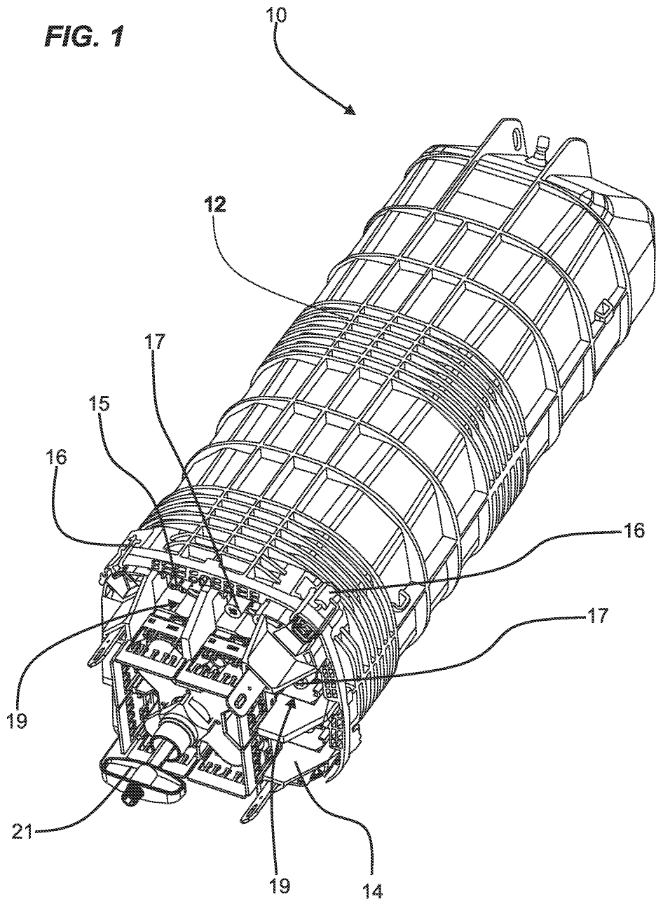

Referring to FIG. 1, example telecommunications equipment 10 is shown. In the depicted example, the equipment 10 includes a sealable and re-enterable closure. In other examples, the equipment can include other components at a distribution location of an optical fiber network. Such equipment can include, for example, a cabinet, a drawer, a shelf, or a panel for organizing and routing optical fibers.

The closure 10 includes a first housing piece 12 (in this case, a dome), and a second housing piece 14 configured to cooperate with the first housing piece to define a sealable and re-enterable telecommunications closure for managing optical fibers. The first and second housing pieces 12, 14 define an interior closure volume in which other fiber managing equipment can be housed.

Clamps 16 can be used to compress a seal element between the housing pieces 12 and 14 and thereby clamp and seal together the housing pieces 12 and 14. An actuator 21 can be used to compress sealing elements around the cables entering the closure and/or to compress a seal element between the housing pieces.

Cables (such as cables 15 and 17) carrying optical fibers can enter the closure volume via sealable ports 19 defined by the second housing piece 14. Such cables can include trunk cables, feeder cables, branch cables, and distribution cables (also known as drop cables). Likewise, electrical grounding conductors or cables can sealingly enter the closure in the same manner.

Typically, optical fibers from one cable entering the closure are spliced to optical fibers of one or more other cables entering the closure to establish an optical signal path at the closure 10 (or other signal distribution equipment) from a provider side cable to one or more customer side cables. In this manner, optical signals can be transmitted from one cable to another cable via the closure 10, e.g., from a feeder cable to a drop cable, from a feeder cable to another feeder cable (that feeds another closure), from a feeder cable to a branch cable (which branches out to multiple other terminals), etc.

In addition to splicing, other fiber management activities can be performed with telecommunications equipment housed within the closure volume. Such activities can include, without limitation, indexing fibers, storing fibers (typically in one or more loops) splitting signals of fibers, and establishing optical connections with connectorized fibers and adapters, etc.

Splices, such as mechanical splices or fusion splices, can be performed at the factory or in the field, e.g., at the closure 10 positioned in the field.

The cables entering the closure can include fibers of different configurations such as loose fibers and fiber ribbons. The fiber ribbons can be flat ribbons or rollable ribbons. The loose fibers can be individual fibers or bundled loose fibers protected by a common protective sheath or tube. For fiber ribbons, the fibers of the entire ribbon can be spliced to the fibers of a corresponding fiber ribbon at the same time, e.g., using a mass fusion splicing procedure.

Splice bodies protect the splices both in the case of individual fiber splices and mass fiber splices, such as mass fusion splices. The splice bodies are held in splice holders also known as splice chips. Fiber management trays can support such splice holders (or chips). The fiber management trays can be stacked in stacks to support modules mounted to a frame all housed within the closure volume. The trays are pivotal relative to the support modules such that a desired tray in the stack can be accessed by pivoting one or more of the trays away from the desired tray.

As used herein, positioning and orientational terms such as up, down, upper, lower, above, below, front, back, rear, forward, backward, rearward, horizontal, vertical, and so forth, may be used to refer to relative positioning of components in an assembly or portions of a component relative to each other when positioned in an assembly. Such terminology is provided as a descriptive aid and does not limit how components or portions of components may be positioned or oriented in practice.

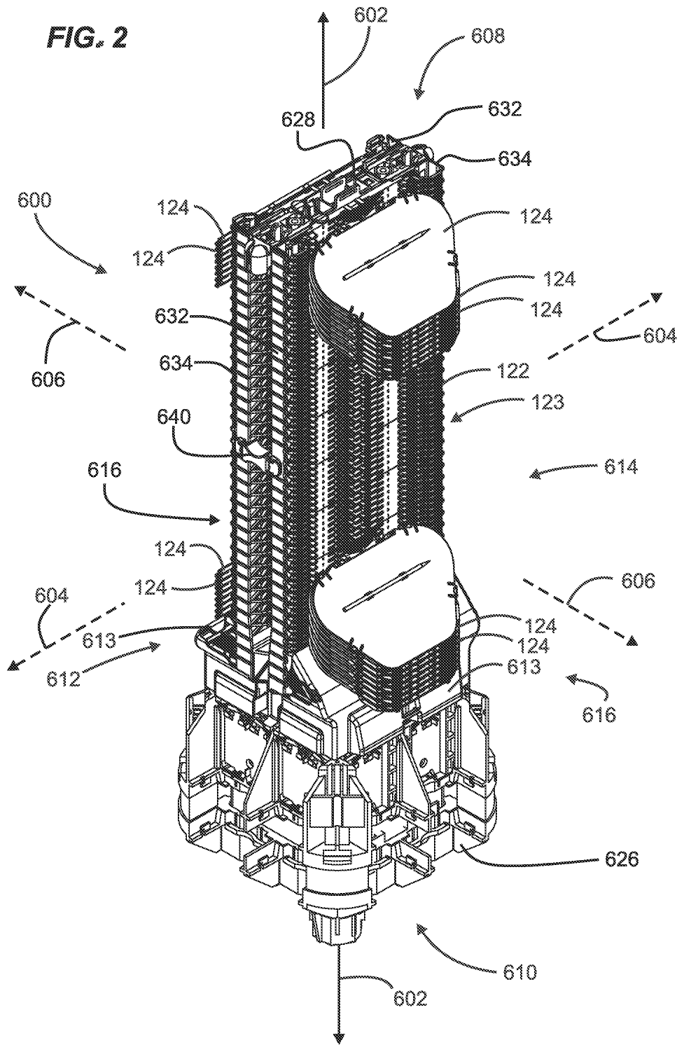

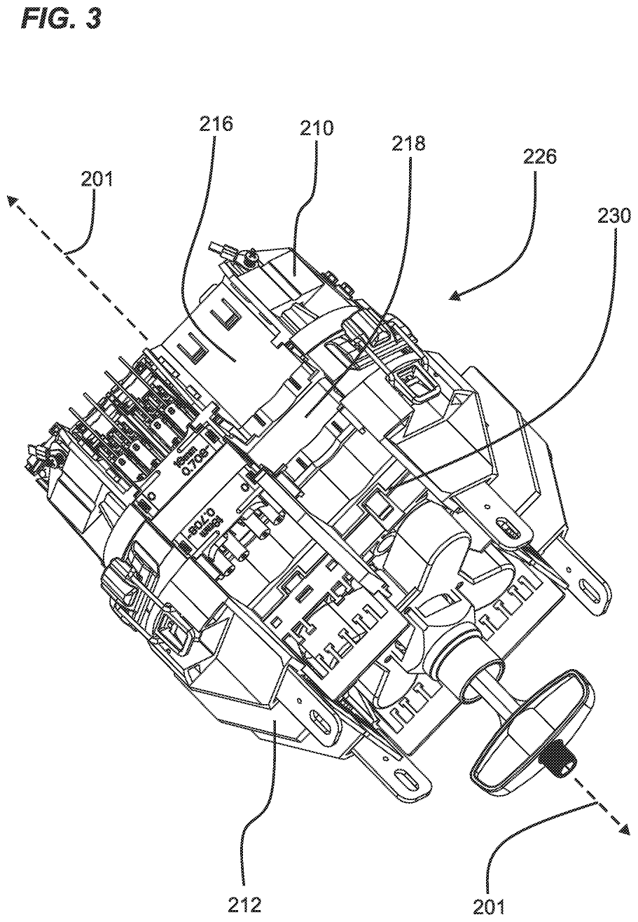

FIG. 2 is a perspective view of a portion an example fiber management assembly 600, a portion of which can be housed in the closure of FIG. 1. The assembly 600 includes components or types of components that can be mounted to the base assembly of FIG. 3.

The assembly 600 defines a first axis, or vertical axis 602, a second axis 604, and a third axis 606. The first axis 602, the second axis 604, and the third axis 606 are mutually perpendicular. The second axis 604 and the third axis 606 define a horizontal plane. The assembly 600 extends from a top 608 to a bottom 610 along the first axis 602. The assembly 600 extends from a first side 612 to a second side 614 along the second axis 604. The assembly 600 extends from a front 616 to a back 618 along the third axis 606.

The assembly 600 includes a framework (or frame) 620 consisting of a number of frame members.

The assembly 600 also includes front and back stacks 123 of fiber management tray support modules 122. The stacks 123 are back-to-back mounted to the framework 220. However, in other examples, only one stack of tray support modules is provided on either the front or the back of the framework. In such examples, a fiber loop storage basket can be provided on the other side of the framework. The tray support modules 122 pivotally support stacks of fiber management trays 124, such as splice trays.

In some examples, the frame 620 can be added to along the vertical axis 602 to accommodate additional modules 122.

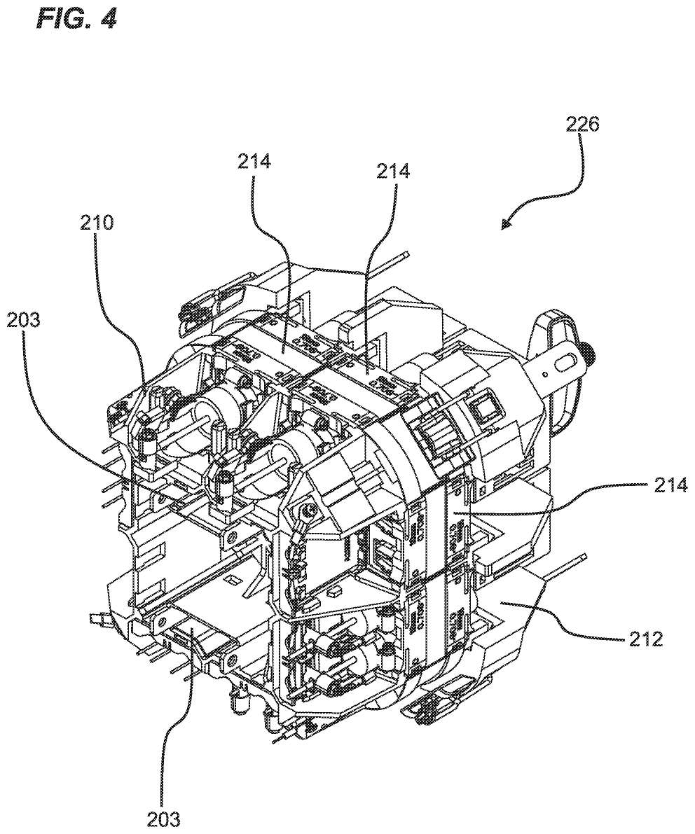

The frame 620 attaches to a base 626. In a like fashion, the frame 620 can attach to the base assembly 226 of FIG. 3. For example, the uprights of the frame 620 can snap connect within pockets 203 of the base assembly 226 (FIG. 4), with the frame 620 extending along an elongate dimension of the frame away from the actuator and parallel to the axis 602.

The frame 620 includes a top member 628. The frame 620 also includes two side members (also referred to as uprights or module support members) 632 having a first upright configuration, and two side members (also referred to as uprights or module support members) 634 having a second upright configuration.

When assembled in the framework 620, each stack 123 of modules 122 is mounted to a pair of the uprights. In the assembled framework configuration pairs of the uprights are snappingly connected to each other.

The framework 620 includes spacer members 640, which help maintain a fixed distance between the uprights to define a loop storage volume between the front uprights and the back uprights.

Each of the components of the framework 620 just described can be constructed from a suitably strong and rigid material that can readily accommodate snappable couplers. For example, all of the components can be constructed from a polymeric material.

The assembly 600 includes two fiber routing modules which can be covered by covers 613. The fiber routing modules can include routing structures (e.g., curved walls) to guide optical fibers to one side or another side of the frame and then upward to desired tray 124. Optionally, if the assembly includes just one vertical stack of fiber management tray supporting modules, then the assembly can include just one fiber routing module.

Optionally, each fiber routing module can also include structures for mounting sheath holders. Such sheath holders can hold protective sheaths or tubes containing optical fibers extending from cables passing through the seal blocks supported in pockets of the base 626 and fixed in the interior of the closure.

Once on a fiber routing module, the fibers can emerge from ends of the sheaths and be routed along pathways defined by the routing module and then up routing channels 615 defined by the uprights 632, 634 and the tray support modules 122 to a specific tray 124 supported by a tray support module 122, on which the fiber is managed as needed (e.g., with a splice to a fiber of another cable entering the closure, with the splice being held on the tray). In addition, some fibers can remain in the protective sheaths and are routed to the interior loop storage volume between the stacks of the tray support modules.

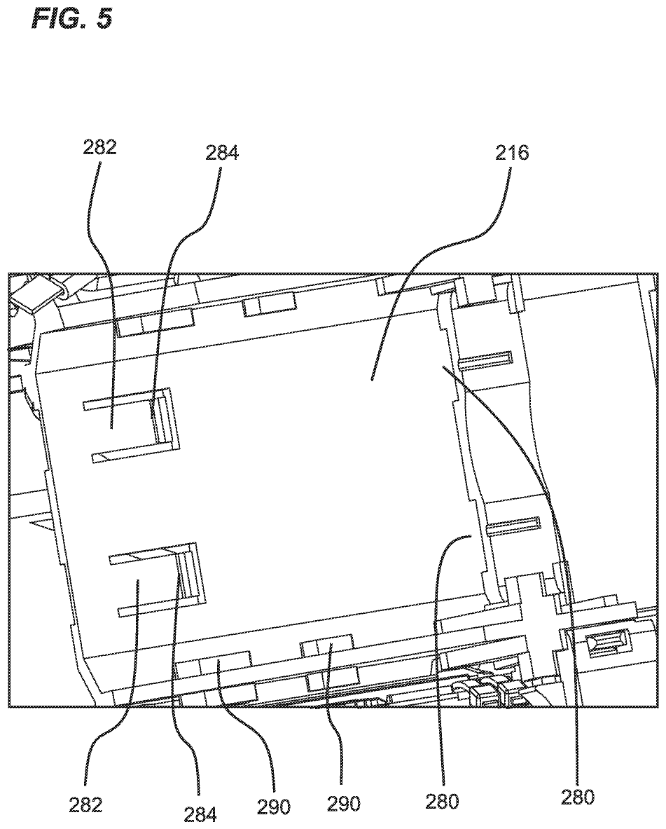

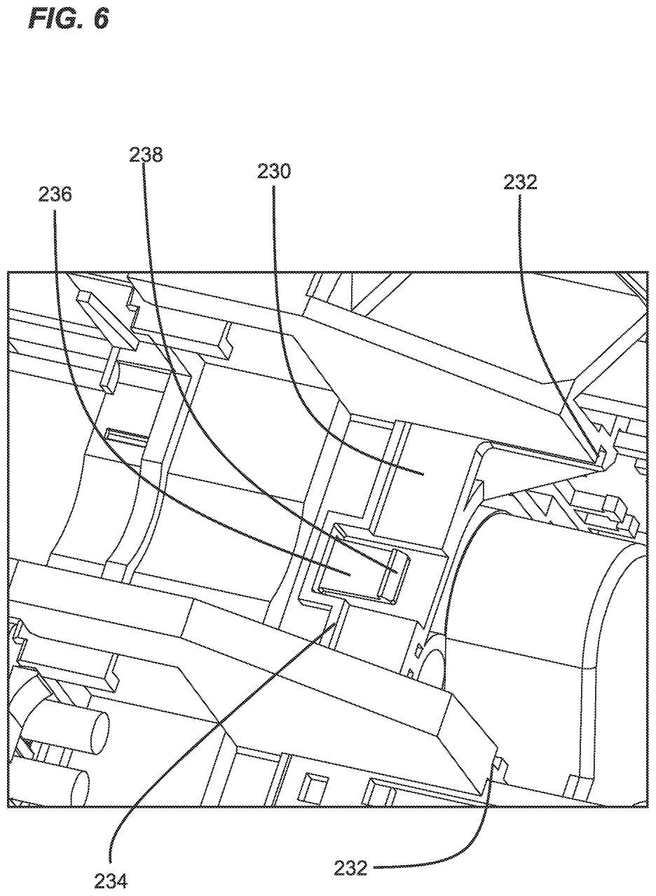

FIG. 3 is a perspective view of the base assembly 226 of the equipment of FIG. 1. FIG. 4 is a further perspective view of the base assembly 226 of FIG. 3. FIG. 5 is a perspective view of a portion of the base assembly 226 of FIG. 3. FIG. 6 is a perspective view of a further portion of the base assembly 226 of FIG. 3.

Referring to FIGS. 3-6, the base assembly 226 includes a first base piece 210 and a second base piece 212. The second base piece 212 corresponds to the housing piece 14 (FIG. 1).

Cables of different sizes and shapes can enter the closure through the base assembly 226. Such cables pass through seal modules 214. Each seal module includes one or more sealing members (e.g., gel blocks) that are housed in seal block retainers. The actuator can compress the seal members around the cable. As used herein, a portion of a cable that is exterior to a closure volume is on the exterior (non-sealed side) of a corresponding seal module 214, and a portion of a cable that is interior to a closure volume is on the interior side of a corresponding seal module 214 and therefore within the closure volume when the closure is sealed up. The modules 214 are arranged circumferentially around the axis 201, which is parallel to the elongate dimension of the closure.

Each module 214 can be dedicated to a particular type of cable. For example, some modules 214 can seal around drop cables, others around flat cables, others around round feeder cables, etc. The drawings show a variety of cable types passing through modules 214.

Arranged around the axis 201, the first base piece 210 defines receivers 216 for mounting interior cable fixation subassemblies. In addition, each receiver 216 is associated with a receiver 218, also defined by the first base piece 210, for mounting a seal module 214.

Arranged around the axis 201, the second base piece 212 defines receivers 230. Each receiver 230 is associated with (e.g., aligned parallel to the axis 201 with) a corresponding receiver 218 and a corresponding receiver 216 defined by the first base piece 210. Each receiver 218 is configured for mounting an exterior cable fixation subassembly or component.

Thus, a given cable can have a jacketed exterior portion affixed to a subassembly or a component mounted to a receiver 230, while a jacketed interior portion of the cable is affixed to a subassembly or component mounted to the corresponding receiver 216, and a jacketed portion of the cable in between the interior and exterior portions passes through a seal module 214 mounted in the corresponding receiver 218.

For some cables and/or some applications, closure sealing and/or minimizing of cable movement (which can damage optical fibers) can be improved by affixing the cables to the closure at both interior and exterior sides of the seal module.

Referring to FIG. 6, the exterior receiver 230 defines side slots 232, a stop wall 234, and a flexibly resilient tab 236 having a catch 238. Each of these features can be unitarily integrated with the base piece 212.

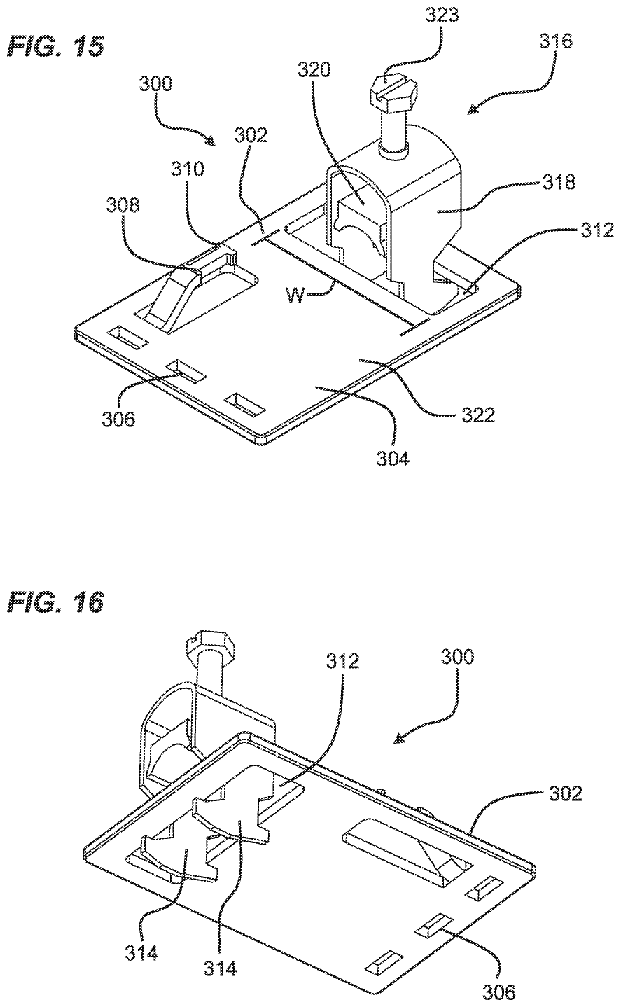

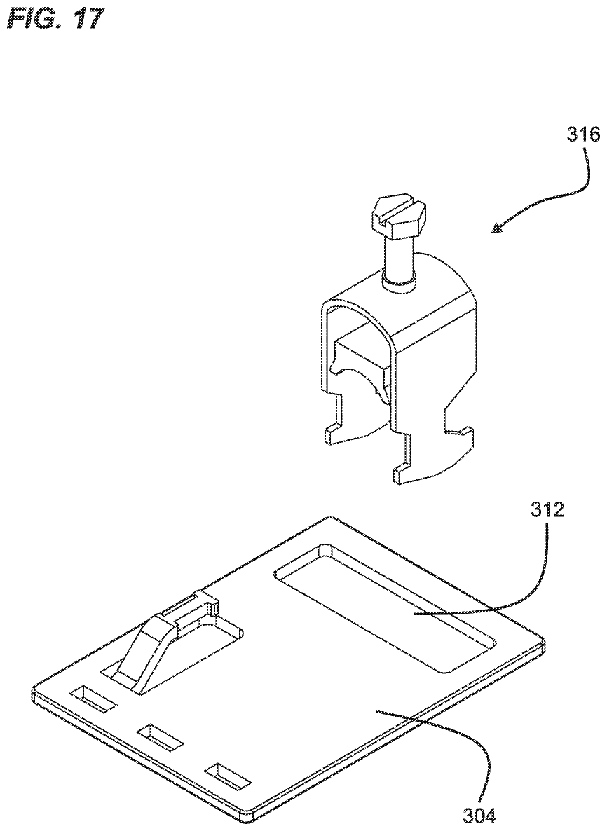

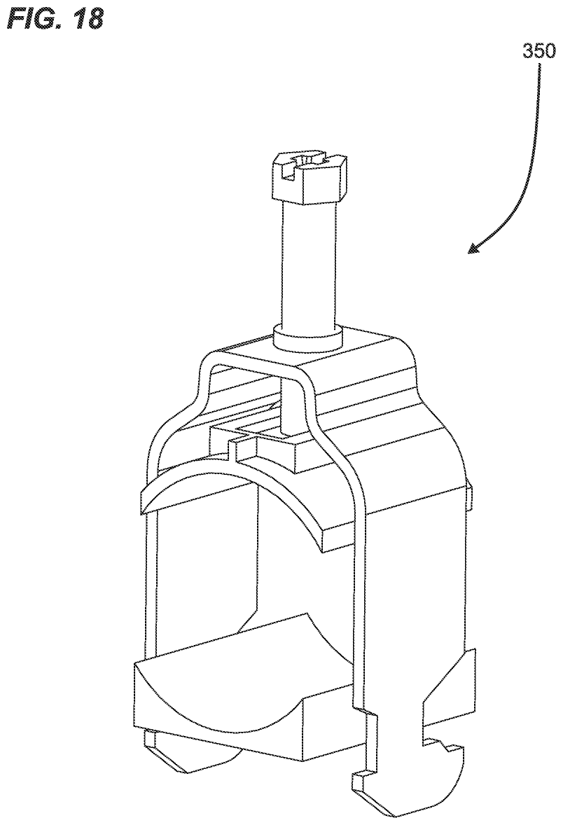

Referring to FIGS. 15-16 an exterior cable fixation subassembly 300 is shown. The subassembly includes a support body 302 that can be constructed of plastic and/or metal. The support body includes a plate 304 with a through hole 306 extending therethrough. A tie mount 308 extends from the plate 304.

A cable, such as signal carrying cable, a grounding cable, or a grounding rod extending into the closure can be fixed to the subassembly 300 exterior to the closure volume with a tie wrap (e.g., a zip tie) that ties around the cable jacket or rod and around the tie mount 308. A T-structure 319 of the mount 308 can stop the tie wrap from falling off the mount 308.

The plate 304 also defines a fully enclosed opening 312. The opening 312 receives and slidingly retains the feet 314 of a cable clamp assembly 316. The opening 312 is wide enough along the dimension W to allow the clamp assembly 316 to slide within the opening 312 along the dimension W. This can facilitate proper cable positioning, by allowing the cable to “float” by sliding along the width dimension W for better alignment with the corresponding seal element.

The clamp assembly 316 includes a body 318 having the feet 314 and a clamping piece 320 received in the body 318. A distance of the clamping piece 320 relative to the surface 322 of the plate 304 can be adjusted with a fastener 323. In this manner, the clamp assembly 316 can be adjusted to accommodate different cable thicknesses. The cable can then be clamped between the piece 320 and the surface 322.

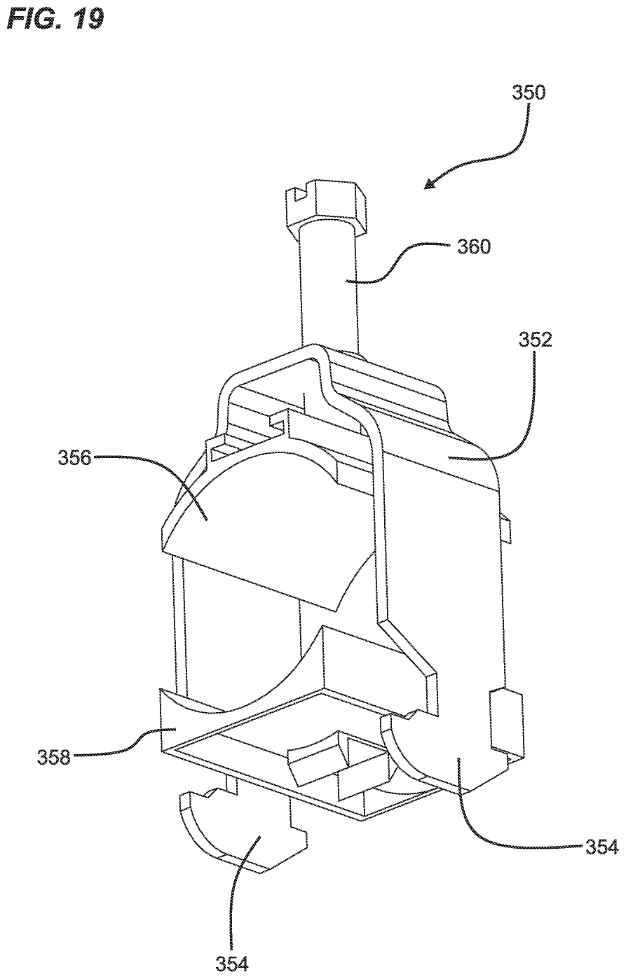

Referring to FIGS. 18-19, the clamp assembly 350 can substitute for the assembly 316 and be adjustably mounted to the same support body 302 as described with respect to the clamp assembly 316. The claim assembly 350 includes a body 352 having feet 354 that can be received through the opening 312 and retained therein as described above. The clamp assembly 350 can be more suitable for larger or smaller cables than the clamp assembly 16. The clamp assembly 350 includes first and second clamping pieces 356 and 358 that clamp around a cable. A fastener 360 can be rotated to adjust a distance between the clamping pieces 356 and 358 to adjust the clamp assembly for differently sized cables.

The plate 304 is configured to slide into the slots 232 (FIG. 6) until the edge of the plate 304 abuts the stop wall 234 and the catch 238 of the tab 236 resiliently snaps into the through hole 306 to thereby securely mount the support body 302 within the receiver 230.

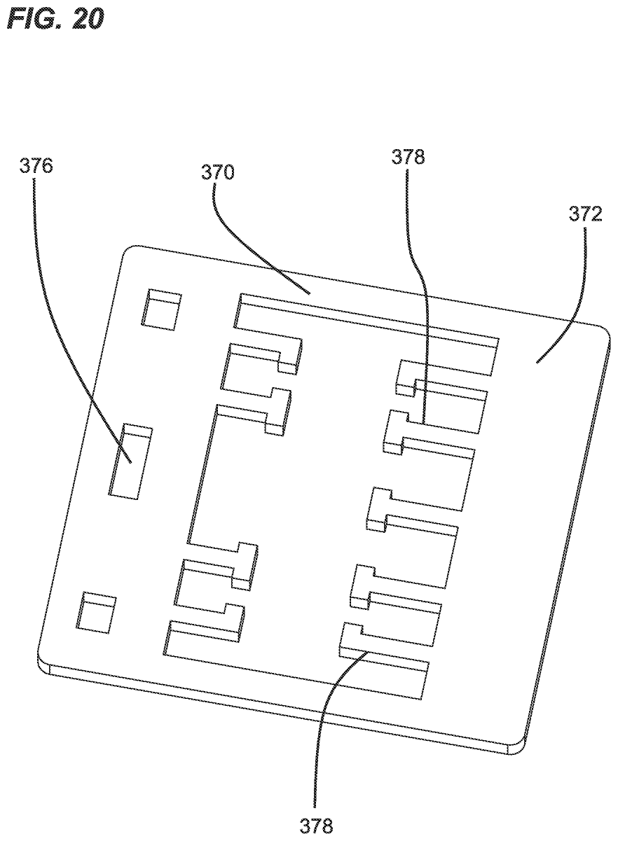

Referring to FIG. 20, a further example support body 370 for exterior cable fixation is shown. The support body 370 includes a plate 372 that can mount in a receiver 230 in the same manner just described, with the catch 238 being received in the through hole 376. Projecting from the plate are structures 378 for mounting and retaining tie wraps tied around cables or grounding rods.

Referring to FIG. 5, the interior receiver 216 defines pockets 280 and flexibly resilient tabs 282 having catches 284. Each of these features can be unitarily integrated with the base piece 210. The features of each receiver 216 is configured to securely mount different types of interior cable fixation subassemblies.

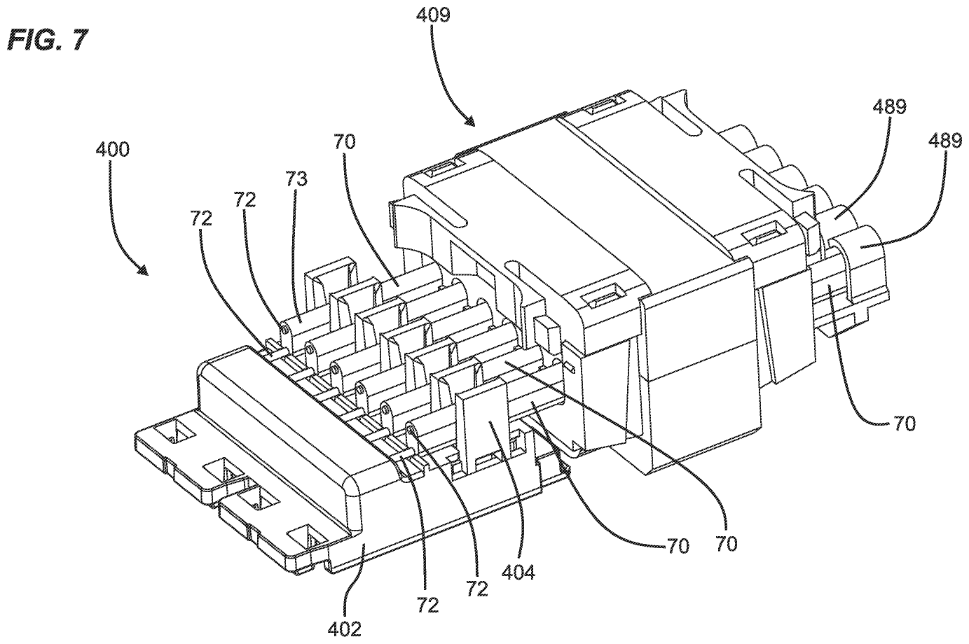

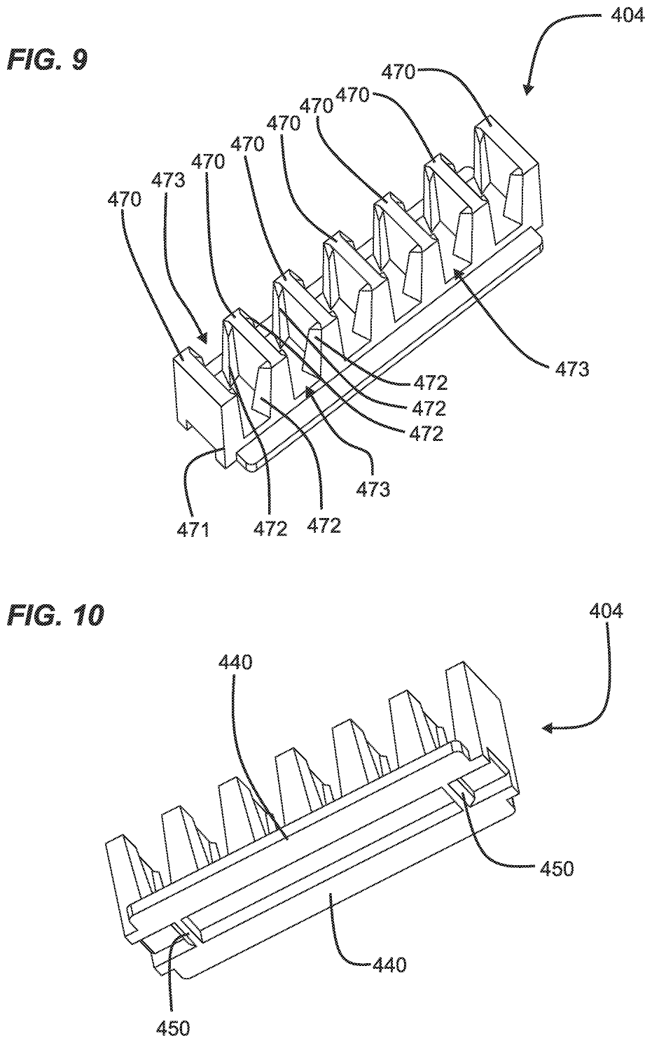

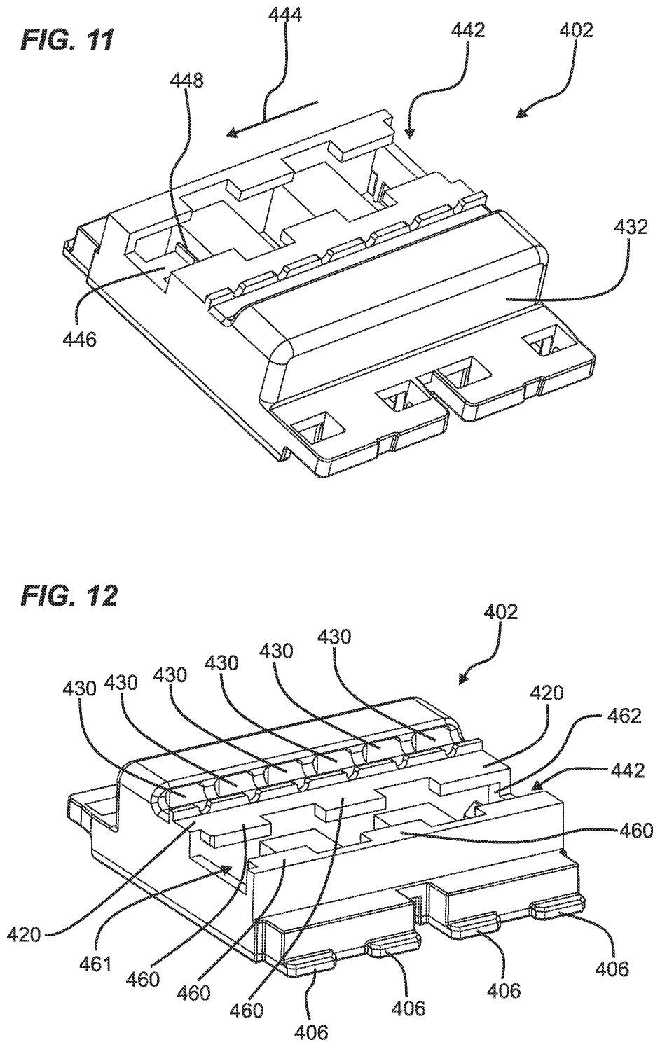

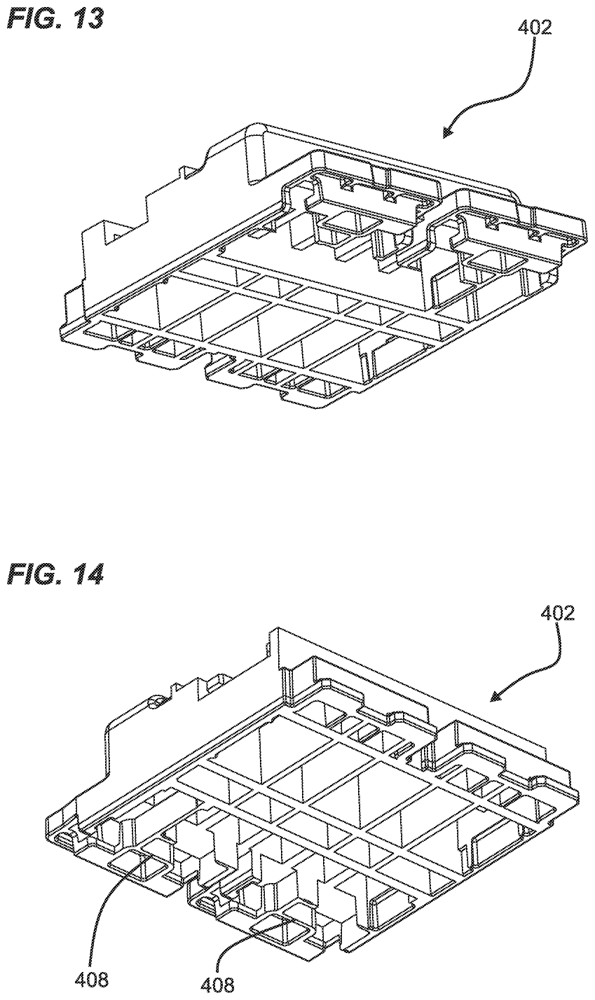

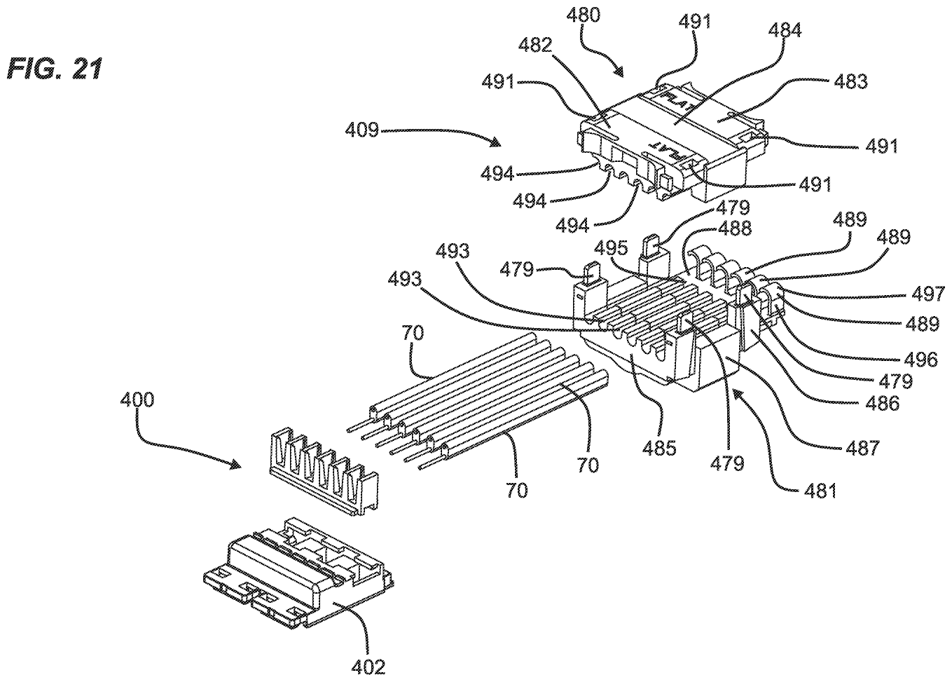

Referring to FIGS. 7-14 and 21, an example interior cable fixation subassembly 400 is shown and will now be described. The subassembly 400 is configured to affix non-round cables, such as flat cables 70. The subassembly 400 is shown in FIGS. 7, 8 and 21 together with a sealing module 409.

Due their non-round cross-sectional profiles, non-round cables can be difficult to affix to telecommunications equipment with typical fixation components, such as hose clamps and tie wraps, which are better suited for clamping around jackets with round profiles. For instance, using a hose clamp to clamp a flat cable 70 having an outer jacket 73 can result in gaps between the flat portions of the jacket 73 and the hose clamp, which make the clamping detrimentally loose.

In addition, some non-round cables such as the flat cables 70, can include multiple and eccentric rigid strength rods 72. Typical cable fixation assemblies can accommodate fixation of a single central strength rod, but not are not necessarily equipped to accommodate one or more eccentric (e.g., away from the central longitudinal axis of the cable) strength rods. Strength rod fixation can be important to minimize creep of a strength rod into the closure volume, which can damage optical fibers.

The subassembly 400 is configured to alleviate one or more of these drawbacks.

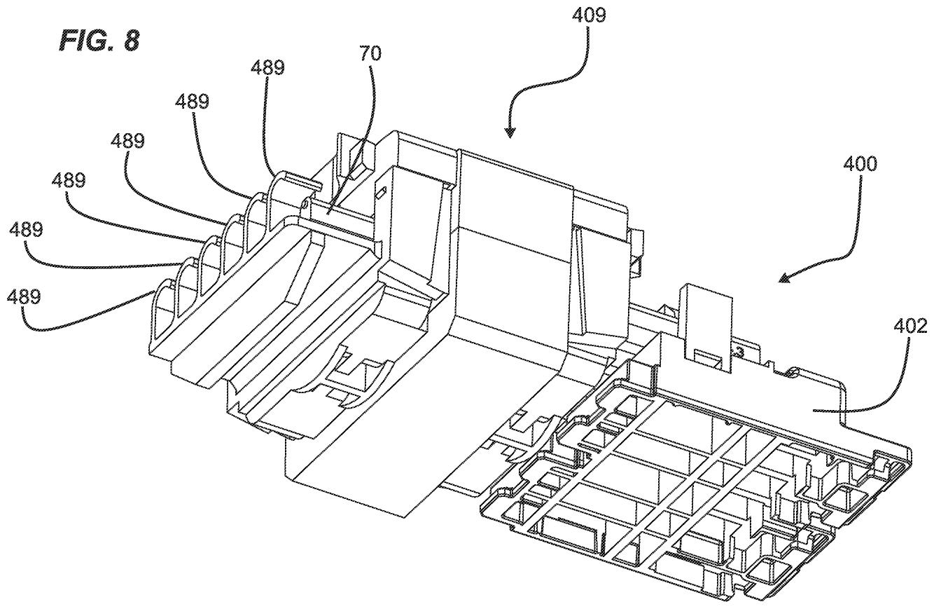

The subassembly 400 is shown in FIGS. 7 and 8 together with a sealing module 409, which functions similarly to other sealing modules described herein, but configured to form seals around non-round cables.

The subassembly 400 includes a main body 402 and a fixation device 404 that mounts to the main body 402.

The main body 402 can be constructed of metal and/or plastic materials. In some examples, all features of the main body 402 are of unitary construction (e.g., made in a single mold).

The main body 402 is configured to securely mount to a receiver 216 or to a pair of side-by-side receivers 216. Specifically, the main body 402 includes feet 406 that are received in the pockets 280 of the receiver(s) 216. As the feet 406 are slid into the pockets 280, the tabs 282 of the receiver(s) resiliently flex until catches 284 snapping engage shoulders 408 of the main body 402, and surfaces 420 can slide under projecting retainer structures 290, thereby locking the main body 402 within the receiver 216.

The main body 402 defines pockets 430 aligned in a row and configured to receive the ends of strength rods of fixed cables. The pockets 430 are closed at the side 432, which can minimize creeping of the strength rods into the closure volume.

The fixation device 404 can be constructed entirely of metal. Alternatively, the fixation device 404 can be constructed of plastic, but with the blade portions constructed of metal. Alternatively, the blade portions can be constructed of plastic. In some examples, the blade portions can be constructed of plastic and unitarily integrated in seamless construction with the rest of the fixation device 404.

The main body 402 includes a receiver 442 that mounts the fixation device 404. A slot 461 of the receiver 442 slidingly receives flanges 440 of the fixation device 404, with the flanges 440 under the tabs 460 and with the fixation device 404 being slid along the direction 444, until the flexibly resilient tab 446 of the main body 402 flexes and the catch 448 of the tab 446 snappingly engages one of the shoulders 450 of the fixation device 404 and further movement of the fixation device 404 along the direction 444 is prevented by a stop wall 462 defined by the main body 402, thereby securely mounting the fixation device 404 to the main body 402.

The fixation device 404 includes a body 471 from which walls 470 project, the walls 470 being arranged in a row. Each pair of adjacent walls 470 defines a cable fixation slot 473 with blades 472 projecting towards each other and towards a center each of retention slot 473 from the corresponding walls 470 on opposite sides. In this example, the fixation slots 473 are configured to receive the cables along their elongate transverse dimension (transverse to the longitudinal axis of the cable). That is, a cable 70 is inserted into a slot 473 in a direction parallel to the cable's elongate transverse axis. This configuration can allow greater density of side-by-side cables fixed to the same subassembly 400. As the cable 70 is inserted in the slot 473, the blades 472 dig into the jacket 73 of the cable (the jacket being constructed of a softer polymeric or elastomeric material than the blades), to affix the cable. Each cable 70 includes optical fibers centrally located or approximately centrally located within the jacket 73 and between the two strength rods 72. One of the eccentric strength rods 72 is received in a corresponding pocket 430, which can also provide additional fixation of the cable, and the other strength rod 72 of the cable 70 can be cut, to minimize potentially damaging creep of the strength rod. In addition, cutting of the additional strength rod 70, as well as fixation of the cable inserted into the fixation device along its transverse elongate dimension, can facilitate routing of the fibers extending from the center of the cable 70 over and beyond the module 400 to other fiber organization components within the telecommunications closure.

Referring to FIGS. 7, 8 and 21, the sealing module 409 includes a first sealing arrangement 480 that mates with a second sealing arrangement 481. To mate the sealing arrangements 480 and 481 together, coupling tabs 479 of the second sealing arrangement 481 enter slots 491 defined by the first sealing arrangement 481.

The first sealing arrangement 480 includes front and back support structures 482 and 483 that support a first gel block 484. Similarly, the second sealing arrangement 481 includes front and back support structures 485 and 486 that support a second gel block 487. The support structures 485 and 486 include the tabs 479, and the support structures 482 and 483 define the slots 491.

Each sealing arrangement 480 and 481 defines a row of longitudinal recesses, which are cable receivers aligned parallel to one another and configured to receive flat cables 70. In the sealing arrangement 480, each cable receiver 494 extends continuously from the support structure 482 to the gel block 484 to the support structure 483. In the sealing arrangement 481, each cable receiver 493 extends continuously from the support structure 485 to the gel block 487 to the support structure 486.

The support structure 486 includes a cable retention member 488. The cable retention member 488 can be integrally formed (e.g., of seamless, molded construction) with the support structure 486. Alternatively, the cable retention member 488 can be a separate piece that is coupled to another piece of the support structure 486.

The cable retention member 488 includes a base 495 from which extend curved cable retainers 489. Each cable retainer is a rounded sleeve-like cable retainer. Each of the retainers 489 is aligned with, and corresponds to, one of the cable receivers 493 that pass through the sealing module 490. Each cable retainer 489 includes a stem 496 extending from the base 495, and a curved stop 497 that extends from the stem 496. Each cable retainer 489 is open on the side opposite the stem 496, such that a cable 70 can be received in a retainer 489 axially (e.g., parallel to the longitudinal axis of the cable) or laterally (e.g., perpendicular to the longitudinal axis of the cable).

The cables 70 are positioned in the receivers 493 and 494 and are thereby captured by the sealing module 490 with the gel blocks 484 and 487 forming seals around the cables 70. To assemble the sealing module 490 and thereby form seals around the cables 70 each cable is routed through one of the holders. The cables 70 are pressed into the module 400 such that the blades 472 dig into portions of the jackets 73 of the cables 70 further on from the sealing module 490. In some examples, the blades embed in the cable jackets 73. In some examples, the blades can embed into the strength members of the cables 70.

The gel blocks 484 and 487 form a “wrap around” configuration that wraps around the cables 70. To install cables in the module 400 and the module 490, one of the sealing arrangements 480, 481 is removed from the other, the cables 70 are routed across the gel of one of the arrangements, and then the other arrangement is mated with the first arrangement capturing the cables between the gel blocks of the two arrangements. If a cable needs to be added, the sealing module 490 is removed from the closure and the arrangement 480 is removed from the arrangement 481. However, the gel can be sticky, which can cause already installed cables to pull out of the receivers 493 of the arrangement 481, as well as out of the blades 472, such that the already installed cables detrimentally become unfixed from the module 400, since the detachment direction of the arrangement 480 relative to the arrangement 481 is opposite to the insertion direction of the cables between the blades. To minimize or eliminate this issue, the retainers 489 are provided, which can server to hold down the cables 70, causing them to stay in place and in contact with the arrangement 481 and with the blades 472 when the arrangement 480 is removed from the arrangement 481.

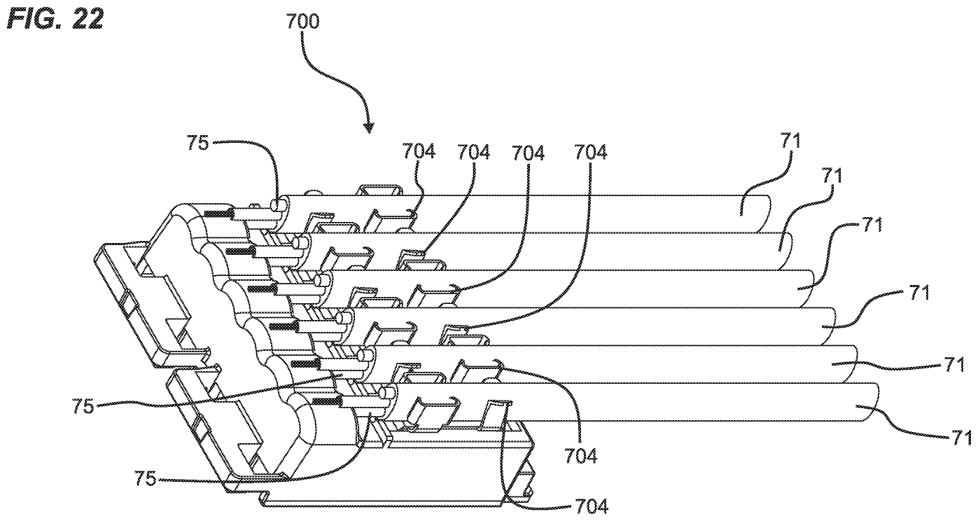

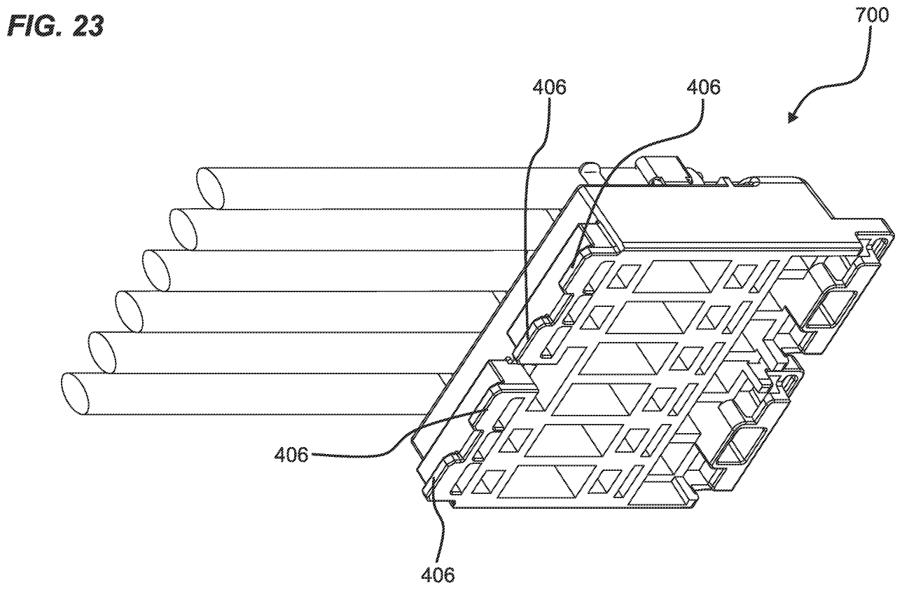

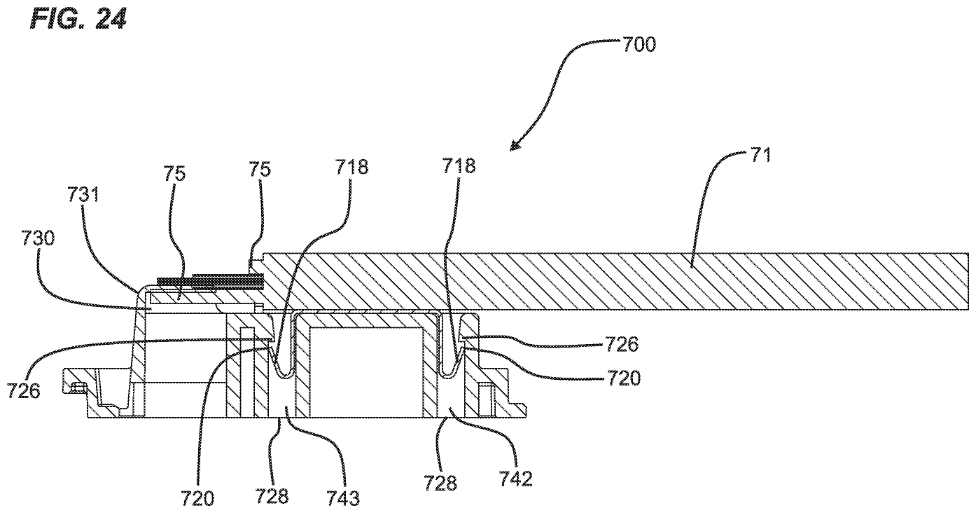

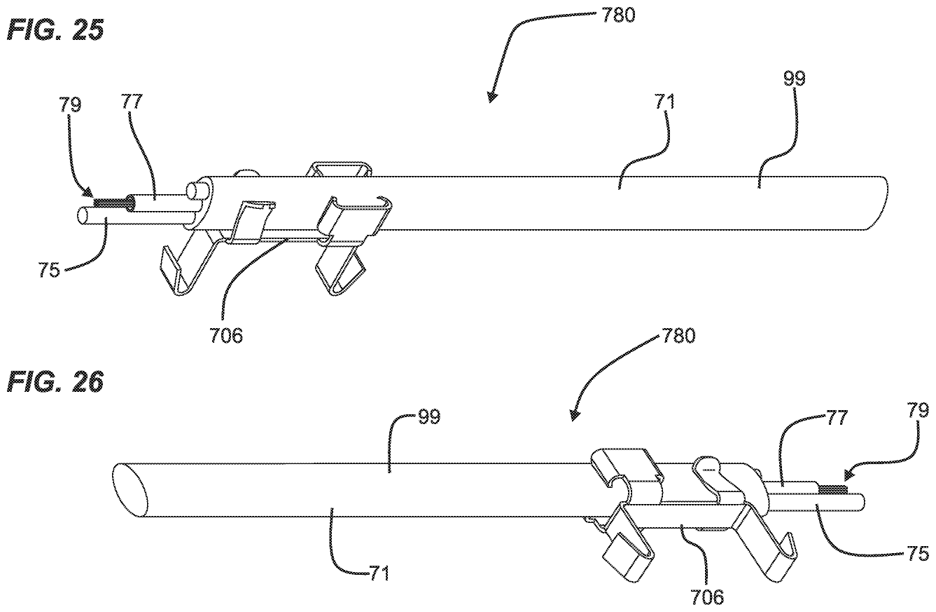

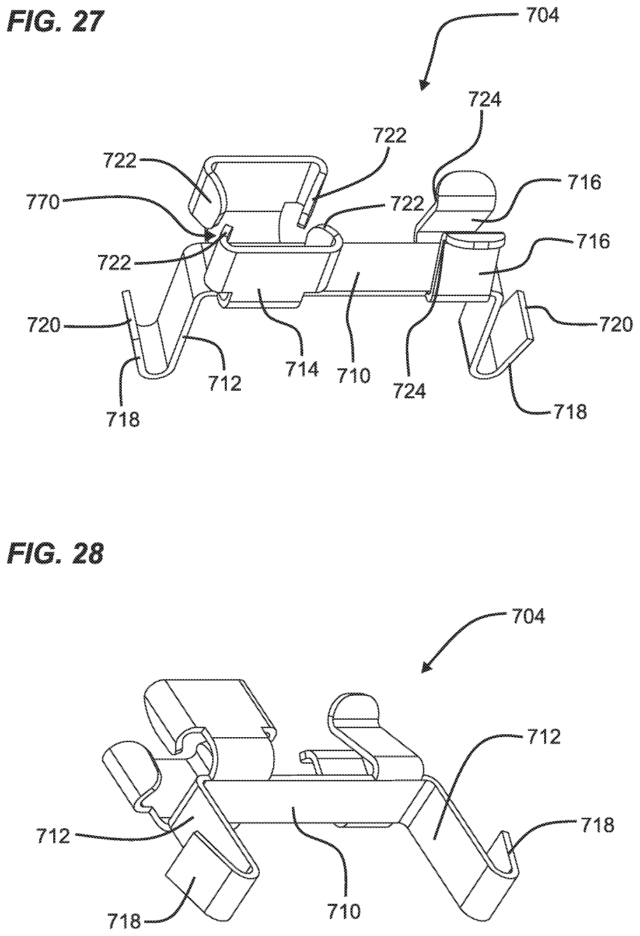

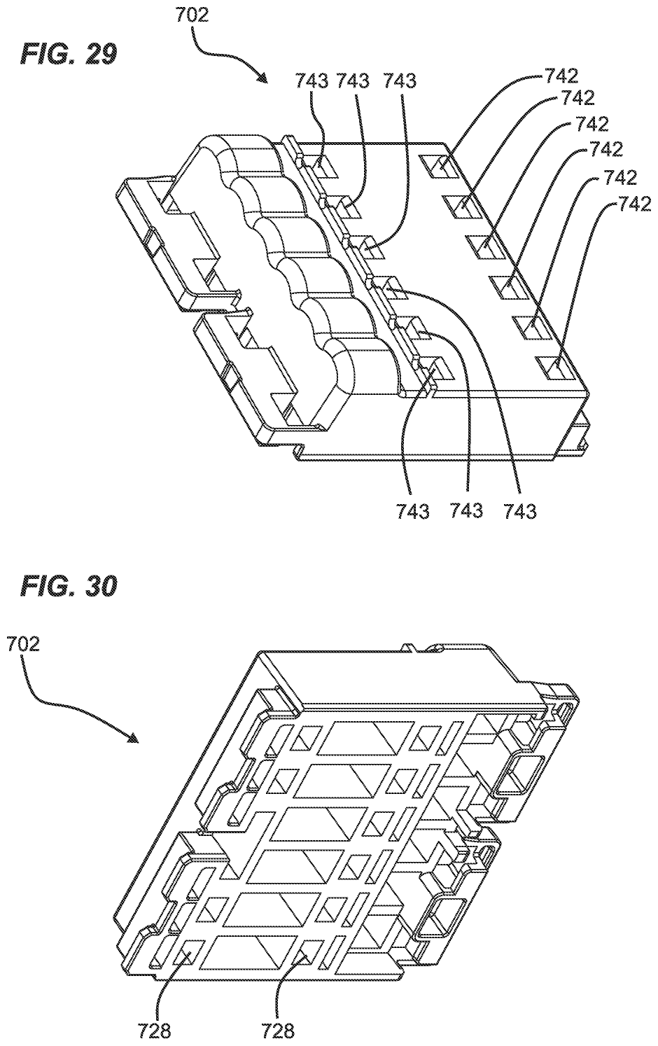

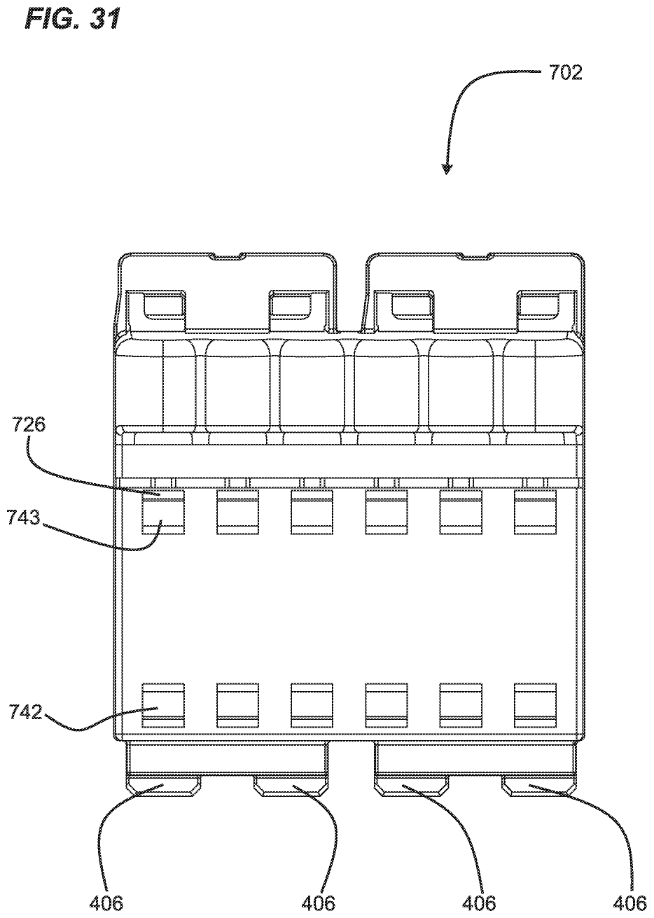

Referring to FIGS. 22-31, a further example interior cable fixation subassembly 700 is shown and will now be described. The subassembly 700 is configured to affix non-round cables containing one or more optical fibers 79, such as flat cables 70, or cables with oval cross-sections, such as oval cables 71. The optical fibers 79 can be sheathed in a protective sheath 77 that runs along the cable within the cable jacket 99. The subassembly 700 can be combined with a sealing module 409 in the manner described above with respect to the subassembly 400, and placed in the interior of a closure, such as the closure 10, in the manner described above with respect to the subassembly 400.

The subassembly 700 is configured to accommodate a wider range of cable thicknesses (thickness perpendicular to the longitudinal axis of the cable) of non-round cables than the subassembly 400.

The subassembly 700 includes a main body 702 and cable fixation devices 704 that mount to the main body 702. Each cable fixation device 704 can affix one non-round cable. Each cable fixation device 704 is configured to securely lock into a receiver in the main body 702. In some examples, the cable fixation devices 704 are arranged side by side in a row in alternating orientations. For example, one cable fixation device 704 is arranged in its corresponding receiver of the main body 702 in a front to back orientation and an adjacent cable fixation device 704 is arranged in its corresponding receiver of the main body 702 in a back to front orientation. The alternating orientations of the cable fixation devices 704 can allow the subassembly 700 to accommodate thicker cables, as will be described in more detail below.

The main body 702 can be constructed of metal and/or plastic materials. In some examples, all features of the main body 702 are of unitary construction (e.g., made in a single mold).

The main body 702 is configured to securely mount to a receiver 216 or to a pair of side-by-side receivers 216, as described in connection with the main body 402. For example, the main body 702 includes feet 406 that are received in the pockets 280 of the receiver(s) 216. The feet 406 are slid into the pockets 280, and other features engage the main body 702 within the receiver 216, as described in connection with the main body 402.

The main body 702 defines pockets 730 aligned in a row and configured to receive the ends of strength rods 75 of fixed cables 71. There is a pocket 730 for each cable and aligned with the receiver of the cable fixation device of the corresponding cable. The pockets 730 are closed at the distal side 731, which can minimize creeping of the strength rods into the closure volume.

The fixation device 704 can be constructed entirely of metal. Alternatively, the fixation device 704 can be constructed of plastic, but with the blade portions constructed of metal. Alternatively, the blade portions can be constructed of plastic. In some examples, the blade portions can be constructed of plastic and unitarily integrated in seamless construction with the rest of the fixation device 704. In some examples, the fixation device 704 is made from a single piece of sheet metal that is bent into the configuration shown in the figures.

The main body 702 includes receivers 742 and 743. The receives 742 are arranged in a row. The receivers 743 are arranged in a row. A pair of one receiver 742 and one receiver 743 aligned parallel to the longitudinal axis of a cable is configured to mount a fixation device 704.

Each cable fixation device 704 includes a base 710. Extending from the base 710 are legs 712, a pair of opposing arms (or walls) 714, and a pair of opposing arms 716. Each pair of arms 714 and 716 are flexibly resilient as they are flexed toward and away from each other (toward and away from the longitudinal axis of the base 710). The legs 712 are flexibly resilient as they are flexed toward and away from each other, parallel to the longitudinal axis of the base 710.

Extending from each leg 712 is a hook 718 defining a catch 720. The hooks 718 face away from each other. Extending from each arm 714 is a blade 722. The blades 722 of each cable fixation device 704 oppose each other. Each arm 716 includes a recessed clamping portion 724.

To install a fixation device 704 in the main body 702, the legs 712 are inserted into a pair of aligned receivers 742 and 743, causing the hooks 718 of the legs 712 to flex toward each other until the hooks 718 clear shoulders 726 within the receivers 742 and 743. Once the hooks 718 are clear of the shoulders 726, the catches 720 can engage the shoulders 726 to stop the fixation device 704 from being removed from the receivers 742 and 743. Access openings 728 at the bottom of the main body 702 can allow a tool to access each hook 718 to flex the hook 718 so that the catch 720 can clear the shoulder 726, allowing the cable fixation device 704 to be removed from the body 702.

To install a cable (e.g., a cable 71) into a cable fixation device 704, the jacket of the cable 1 is slid along its longer transverse dimension towards the base 710 of the fixation device 704, causing the arms 716 to resiliently flex around the jacket of the cable such that the clamping portions 724 apply spring pressure on opposite sides of the jacket to clamp the jacket. Meanwhile, the opposing blades 722 can dig into the jacket of the cable 71. The blades 722 and clamping portions 724 provide multiple locations along the longitudinal axis of the cable 71 to stably secure and fix a non-round cable.

In some examples, a subassembly 780 of a cable and fixation device 704 is first assembled, and then the subassembly 780 is installed in the main body 702, by first inserting the strength rod 75 in a pocket 730, and then installing the fixation device 704 in the corresponding receivers 742 and 743. In other examples, the fixation device 704 is first installed in a pair of receivers 742 and 743, and then a cable is added by inserting the strength rod in the corresponding pocket 730 and then inserting the cable jacket in the slot 770 defined between the arms 714 and 716 of the pre-installed fixation device 704, causing the blades 722 to dig into the jacket 99 of the cable 71 and causing the clamping portions 724 to clamp the jacket 99 by spring force.

In some examples, the cable 71 can include multiple eccentric strength rods 75. One of the eccentric strength rods 75 is received in a corresponding pocket 730, which can also provide additional fixation of the cable, and the other strength rod 75 of the cable 71 can be cut, to minimize potentially damaging creep of the strength rod. In addition, cutting of the additional strength rod 75, as well as fixation of the cable inserted into the fixation device along its transverse elongate dimension, can facilitate routing of the optical fibers 79 extending from the center of the cable 71 over and beyond the module to other fiber organization components within the telecommunications closure.

The receivers 742 and 743 and the fixation device 704 are configured such that the fixation device 704 can be received in a pair of receivers 742 and 743 in either of two orientations that are opposite each other. As shown in FIG. 22, this allows the fixation devices 704 to be installed in row in the main body 702 in alternating orientations, such that the arms 714 of one fixation device 704 are adjacent the arms 716 of an adjacent fixation device 704, and vice versa, and no two adjacent fixation devices 704 have their corresponding arms 716 aligned with each other along the axis of the row, and no two adjacent fixation devices 704 have their corresponding arms 714 aligned with each other along the axis of the row. This provides greater clearance for each pair of arms 714 to flex away from each other, since each pair of arms 716, due its lack of blades, is not as wide along the axis of the row as each pair of arms 714. Due to the greater clearance for each pair of arms 714 to flex away from each other, each fixation device 704 can advantageously accommodate a greater range of cable thicknesses (including thicker cables) than it would be able to if the orientation of the fixation devices 704 were the same.

Various modifications and alterations of this disclosure will become apparent to those skilled in the art without departing from the scope and spirit of this disclosure, and it should be understood that the scope of this disclosure is not to be unduly limited to the illustrative examples set forth herein.

What is claimed is:

1. A fixation device for a cable extending along a central longitudinal axis and having an outer jacket defining a non-round cross-sectional profile perpendicular to the axis, comprising:
a main body;
walls projecting from the main body and defining a slot between the walls, the slot having an open end; and
blades projecting from the walls towards a center of the slot.

2. The device of claim 1, wherein the slot is configured to receive the cable through the open end along a direction parallel to an elongate transverse axis of the cable.

3. The device of any of claims 1-2, wherein the main body includes a pocket configured to receive a strength rod of the cable extending beyond an end of the outer jacket.

4. The device of any of claims 1-3, wherein the blades are constructed of metal or plastic.

5. The device of claim 3, wherein the pocket and the slot are aligned parallel to the axis.

6. The device of any of claims 1-5, further comprising the cable positioned in the slot with the blades digging into the outer jacket.

7. The device of claim 6, wherein the cable is a flat cable.

8. The device of claim 6, wherein the cable includes a pair of eccentric strength rods.

9. The device of claim 8, wherein one of the strength rods is received in the pocket and the other of the strength rods is not received in the pocket.

10. An assembly for affixing cables, each cable extending along a central longitudinal axis and having an outer jacket defining a non-round cross-sectional profile perpendicular to the axis, comprising:
a main body configured to lockingly mount to a piece of a telecommunications closure, the main body defining pockets arranged in a row; and
a fixation device configured to be slidingly received by the main body to lockingly mount the fixation device to the main body, the fixation device including:
a base;
walls projecting from the base and defining slots between adjacent pairs of the walls, each slot having an open end, the slots being arranged in a row parallel to the row of the pockets, each slot being aligned with one of the pockets; and
blades projecting from the walls towards a center of each slot,
wherein each slot is configured to receive one of the cables through the open end along a direction parallel to an elongate transverse axis of the cable while a corresponding one of the pockets receives a strength rod of the cable.

11. A telecommunications closure, comprising:
housing pieces configured to cooperate to define a sealable and re-enterable closure volume; and
the device of any of claims 1-9 or the assembly of claim 10 positioned in the closure volume.

12. An assembly for a telecommunications closure defining an interior volume and an exterior, comprising:
a cable seal member;
an interior cable fixation subassembly positioned in the interior volume on an interior side of the cable seal member, the interior cable fixation subassembly being configured to affix an interior portion of an outer jacket of a cable extending through the cable seal member; and
an exterior cable fixation subassembly positioned at the exterior at an exterior side of the cable seal member, the exterior cable fixation subassembly being configured to affix an exterior portion of the outer jacket of the cable extending through the cable seal member.

13. The assembly of claim 12, wherein the exterior cable fixation assembly includes a support body configured to lockingly attach to a base of the closure exterior to the interior volume.

14. The assembly of claim 13, further comprising a mounting structure extending from the support body, the mounting structure being configured for a tie wrap to be tied around the cable and around the mounting structure.

15. The assembly of any of claims 13-14,
wherein the support body defines an opening, the assembly further including a cable clamp assembly configured to be slidingly received and retained within the opening.

16. The assembly of claim 15, wherein the cable clamp assembly is configured to slide within the opening in a direction perpendicular to a longitudinal axis of the cable when the cable is affixed to the exterior cable fixation subassembly and the cable clamp assembly is retained within the opening.

17. The assembly of claim 15, wherein the cable clamp assembly includes a body that houses one or more clamping pieces and a fastener for adjusting a position of at least one of the one or more clamping pieces.

18. The assembly of claim 17, wherein the body of the cable clamp assembly includes feet that are received and retained within the opening of the support body.

19. The assembly of any of claims 12-18, further comprising the cable, the cable passing through the seal member, the interior portion of the cable being affixed to the interior cable fixation subassembly, and the exterior portion of the cable being affixed to the exterior cable fixation subassembly.

20. A telecommunications closure, comprising:
housing pieces configured to cooperate to define a sealable and re-enterable closure volume; and
the assembly of any of claims 12-19 fixed relative to at least one of the housing pieces, with the interior cable fixation subassembly being positioned within the closure volume and the exterior cable fixation subassembly being positioned not in the closure volume.

21. A method, comprising:
providing a non-round cable having an outer jacket, one or more optical fibers, and a pair of eccentric strength rods having portions extending beyond an end of the jacket;
cutting the portion of one of the rods so that the cut portion is shorter than the portion of the other of the rods;
inserting the portion of the other of the rods in a pocket; and
inserting the jacket into a slot such that blades within the slot dig into the jacket.

22. The method of claim 21, wherein inserting the jacket includes to insert the jacket in a direction that is parallel to an elongate transverse axis of the jacket.

23. The assembly of claim 10, wherein the main body includes cable retention members, each cable retention member including being positioned and configured to stop one of the cables from being pulled out of its slot by a gel block.

24. The assembly of claim 23, further comprising the gel block, wherein the blades are on one side of the gel block and the cable retention members are on an opposite side of the gel block.

25. The fixation device of claim 1, wherein the main body includes a cable retention member positioned and configured to stop the cable from being pulled out of the slot by a gel block.

26. The fixation device of claim 25, further comprising the gel block, wherein the blades are on one side of the gel block and the cable retention member is on an opposite side of the gel block.

27. A fixation device for a cable extending along a central longitudinal axis and having an outer jacket defining a non-round cross-sectional profile perpendicular to the axis, comprising:
a main body;
walls projecting from the main body and defining a slot between the walls, the slot having an open end; and
at least one blade projecting from at least one of the walls towards a center of the slot.

28. An assembly for affixing cables, each cable extending along a central longitudinal axis and having an outer jacket defining a non-round cross-sectional profile perpendicular to the axis, comprising:
a main body configured to lockingly mount to a piece of a telecommunications closure, the main body defining pockets arranged in a row; and
a fixation device configured to be received by the main body to lockingly mount the fixation device to the main body, the fixation device including:
a base;
a pair of walls or arms projecting from the base and defining a slot therebetween, the slot having an open end, the slot being aligned with a corresponding one of the pockets; and
blades projecting from the walls or arms towards a center of the slot,
wherein the slot is configured to receive one of the cables through the open end along a direction parallel to an elongate transverse axis of the cable while the corresponding one of the pockets receives a strength rod of the cable.

29. The assembly of claim 28, wherein the fixation device includes another pair of arms extending from the base, the another pair of arms including recessed clamping portions.

30. The assembly of any of claims 28-29, wherein the fixation device includes a pair of legs extending from the base, the legs including hooks configured to hook shoulders within receivers defined by the main body to lockingly mount the fixation device to the main body, the receivers being aligned with the corresponding one of the pockets.

31. The assembly of any of claims 28-30, wherein the fixation device is constructed entirely from a single piece of sheet metal.

32. An assembly for affixing cables, each cable extending along a central longitudinal axis and having an outer jacket defining a non-round cross-sectional profile perpendicular to the axis, comprising:
a main body configured to lockingly mount to a piece of a telecommunications closure, the main body defining pairs of receivers arranged in a row; and
fixation devices, each fixation device being lockingly received in one of the pairs of receivers, each fixation device including:
a base;
a pair of arms projecting from the base; and
blades projecting from the arms towards each other,
wherein orientations of adjacent ones of the fixation devices are opposite each other, the orientations alternating along a row of the fixation devices.

33. The assembly of claim 32, wherein the main body defines pockets arranged in a row, each pair of receivers being aligned with a corresponding one of the pockets.

34. The assembly of claim 33, wherein each pair of arms defines a slot therebetween and aligned with the corresponding one of the pockets, each slot being configured to receive one of the cables through an open end of the slot along a direction parallel to an elongate transverse axis of the cable while the corresponding one of the pockets receives a strength rod of the cable.

35. The assembly of any of claims 32-34, wherein each fixation device includes another pair of arms extending from the base, the another pair of arms including recessed clamping portions for clamping a cable jacket.

36. The assembly of any of claims 32-35, wherein each fixation device includes a pair of legs extending from the base, the legs including hooks configured to hook shoulders within the pair receivers.

37. The assembly of any of claims 32-36, wherein each fixation device is constructed entirely from a single piece of sheet metal.
